(19) United States
(12) Patent Application Publication
(10) Pub. No.: US 2014/0337878 A1
(43) Pub. Date: Nov. 13, 2014

(54) BROADCASTING RECEIVING APPARATUS AND CONTROL METHOD THEREOF

(71) Applicant: Samsung Electronics Co., Ltd., Suwon-si (KR)

(72) Inventors: Jae-jin SHIN, Seoul (KR); Hung-rok KWON, Suwon-si (KR); Min-chul JUNG, Yongin-si (KR)

(73) Assignee: Samsung Electronics Co., Ltd., Suwon-si (KR)

(21) Appl. No.: 14/246,189

(22) Filed: Apr. 7, 2014

(30) Foreign Application Priority Data
May 9, 2013 (KR) 10-2013-0052429

(51) Int. Cl. H04N 21/438; H04N 21/4405; H04N 21/482; H04N 21/426

(52) U.S. Cl. CPC H04N 21/4384; H04N 21/4263; H04N 21/42623; H04N 21/4405; H04N 21/4821
USPC 725/31; 725/134; 725/41

(57) ABSTRACT

A broadcasting receiving apparatus includes a receiver having a plurality of tuners, a storage configured to store an image received by the receiver and a controller configured to control at least one of the tuners that does not tune to a currently viewed image out of the plurality of tuners, to alternately tune a plurality of channels for preset time, and controls the storage to store a channel information image corresponding to respective channels based on an image tuned to by the at least one tuner.

### CROSS-REFERENCE TO RELATED APPLICATION

This application claims priority from Korean Patent Application No. 10-2013-0052429, filed on May 9, 2013 in the Korean Intellectual Property Office, the disclosure of which is incorporated herein by reference in its entirety.

### BACKGROUND

1. Field

Apparatuses and methods consistent with the exemplary embodiments relate to a broadcasting receiving apparatus and a control method thereof, and more particularly, to a broadcasting receiving apparatus and a control method thereof configured to receive a broadcasting stream from a plurality of channels and to provide broadcasting information through an electronic program guide (EPG).

2. Description of the Related Art

A broadcasting receiving apparatus may receive, and output, broadcasting signals through various routes such as terrestrial, cable, satellite and Internet protocol (IP) and may be implemented as a set-top box or a digital television (DTV). In recent years, the broadcasting receiving apparatus has provided a user with programs of various channels, and attempts have been made for a user to efficiently and intuitively select and view such various programs.

As a part of such attempts, electronic program guide (EPG) service has been commercialized to provide a user with information of various broadcasting programs, and may enhance a user's convenience, compared to the conventional method of changing a viewed channel via channel up/down since the EPG provides information of various available channels.

The EPG may be provided in more various manners since the broadcasting transmission has been transitioned from analog to digital broadcasting. Digital broadcasting compresses program data per channel with high efficiency based on Moving Picture Experts Group (MPEG) specifications, multiplexes and transmits broadcasting signals based on digital modulation, and thus has more strength in efficient use of frequency and availability of broadcasting channels than existing analog broadcasting.

Notwithstanding such strengths, the digital broadcasting has some weaknesses, and a representative example of the weaknesses is an increase in time for changing a channel. In analog broadcasting, it takes a relatively short time to change a channel, whereas in digital broadcasting, it may take 2 or 3 seconds to tune to the channel to be changed, and to descramble the channel.

In one exemplary embodiment, a method for guaranteeing continuity of viewing by providing a user with proper contents during a channel-changing time, and forming an EPG required to do so.

### SUMMARY

Accordingly, one or more exemplary embodiments provide a broadcasting receiving apparatus and a control method thereof which provides electronic program guide (EPG) for a user to efficiently search channels as well as providing a user with proper content during a channel-changing time.

According to an aspect of an exemplary embodiment, there is provided a broadcasting receiving apparatus including a receiver which includes a plurality of tuners, a storage part which is capable of storing therein an image received by the receiver and a controller configured to control at least one of the plurality of tuners that does not tune to a currently viewed image out of the plurality of tuners, to alternately tune to a plurality of channels for a preset time, and to control the storage to store a channel information image corresponding to respective channels based on a images tuned to by the at least one tuner.

The channel information image may include a video clip for preset time or a slide generated from an intra-coded frame (I-frame) extracted from the image.

If a request for changing a channel is received, the controller may output a channel information image corresponding to the requested channel, and if the tuning of the requested channel is completed, outputs an image of the tuned channel.

The broadcasting receiving apparatus may further include an electronic program guide (EPG) generator which generates an EPG which provides broadcasting information of channels and including a plurality of mosaics corresponding to a plurality of channels, wherein the EPG generator generates the EPG including channel information images of channels corresponding to the plurality of mosaics.

The EPG generator may arrange mosaics of the EPG based on at least one of among viewing history, user information and genre.

The EPG generator may generate the EPG by overlaying the channel information image with a text or graphic including information of channels corresponding to the mosaics.

The controller may sequentially tune to channels in the order of channels corresponding to mosaics which are adjacent to the focused mosaic in the EPG.

The receiver may include a plurality of processors configured to descramble images provided by the plurality of tuners based on a right to access, and the storage stores a plurality of images descrambled by the plurality of processors.

If a request for changing a channel is received, the controller may decode and output the channel information images stored in the storage.

The broadcasting receiving apparatus may further include a display configured to display the images and the EPG thereon.

According to an aspect of another exemplary embodiment, there is provided a control method of a broadcasting receiving apparatus including alternately tuning to a plurality of channels for a preset time through at least one of tuners which does not tune to a currently viewed image out of a plurality of tuners and storing a channel information image corresponding to respective channels based on the image tuned by at least one tuner.

The control method may further include receiving a request for changing a channel, outputting channel information images corresponding to the requested channel and outputting an image of the tuned channel if the tuning of the requested channel is completed.

The control method may further include generating an EPG providing broadcasting information of respective channels and including a plurality of mosaics corresponding to a plurality of channels, wherein the generating the EPG includes generating the EPG including channel information images of channels corresponding to the plurality of mosaics.

The generating the EPG may include arranging mosaics of the EPG based on at least one of among viewing history, user information and genre.

The generating the EPG may include generating the EPG by overlaying the channel information images with a text or graphic configured to include information of channels corresponding to the mosaics.

The control method may further include sequentially tuning to channels in the order of channels corresponding to the mosaics which are adjacent to the focused mosaic in the EPG and storing the channel information images.

The control method may further include descrambling an image provided by the plurality of tuners based on a right to access, wherein the storing the channel information images includes storing the plurality of descrambled channel information images.

The control method may further include decoding and outputting the stored channel information images if the request for changing a channel is received.

The broadcasting receiving apparatus may include a display configured to display the image and the EPG thereon.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a control block diagram of a broadcasting receiving apparatus according to an exemplary embodiment;

FIG. 2 illustrates an example of an image which is displayed when a channel is changed;

FIG. 3 illustrates a detailed configuration of a receiver;

FIGS. 4 to 7 illustrate examples of a mosaic electronic program guide (EPG) which is provided by the broadcasting receiving apparatus; and

FIG. 8 is a control flowchart of the broadcasting receiving apparatus according to the exemplary embodiment.

### DETAILED DESCRIPTION OF EXEMPLARY EMBODIMENTS

Below, the exemplary embodiments will be described in detail with reference to accompanying drawings so as to be easily realized by a person having ordinary skill and knowledge in the art. The exemplary embodiments may be embodied in various forms without being limited to the exemplary embodiments set forth herein. Descriptions of well-known parts are omitted for clarity, and the reference numerals refer to the elements throughout.

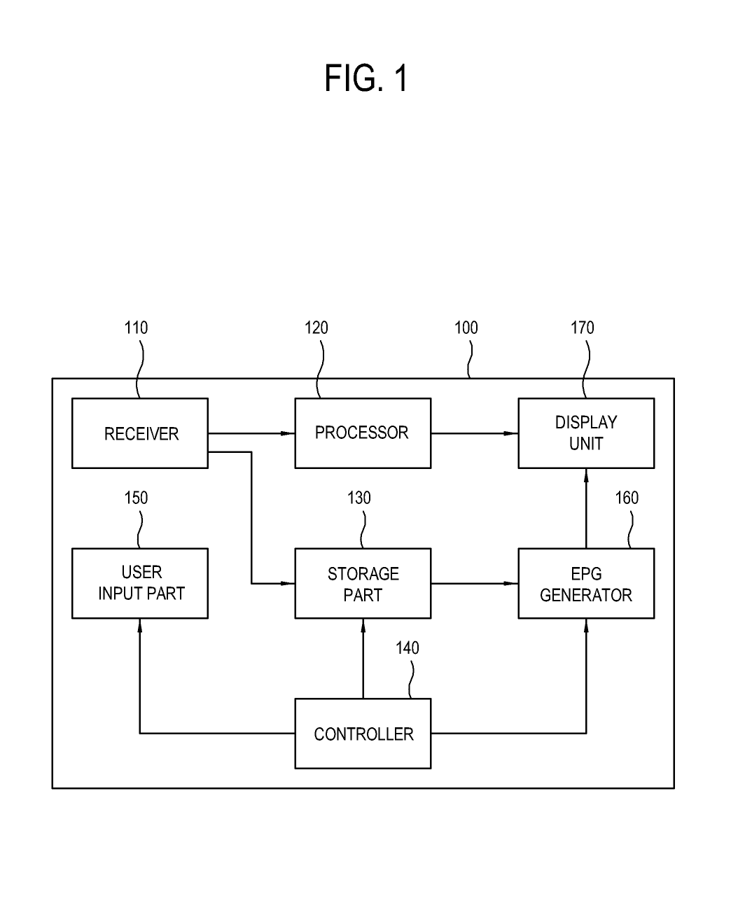

FIG. 1 is a control block diagram of a broadcasting receiving apparatus 100 according to an exemplary embodiment.

As shown therein, the broadcasting receiving apparatus 100 may include a receiver 110, a processor 120, a storage part 130, i.e., storage, a controller 140, a user input part 150, i.e., user input, an electronic program guide (EPG) generator 160, and a display unit 170, i.e., display. The elements shown in FIG. 1 are not mandatory, and omission or addition of the one or more of the elements does not harm the implementation of the broadcasting receiving apparatus 100 according to the exemplary embodiment. The broadcasting receiving apparatus 100 may be configured to receive from the outside, and output, broadcasting signals, and may be implemented as a set-top box or a digital television (DTV).

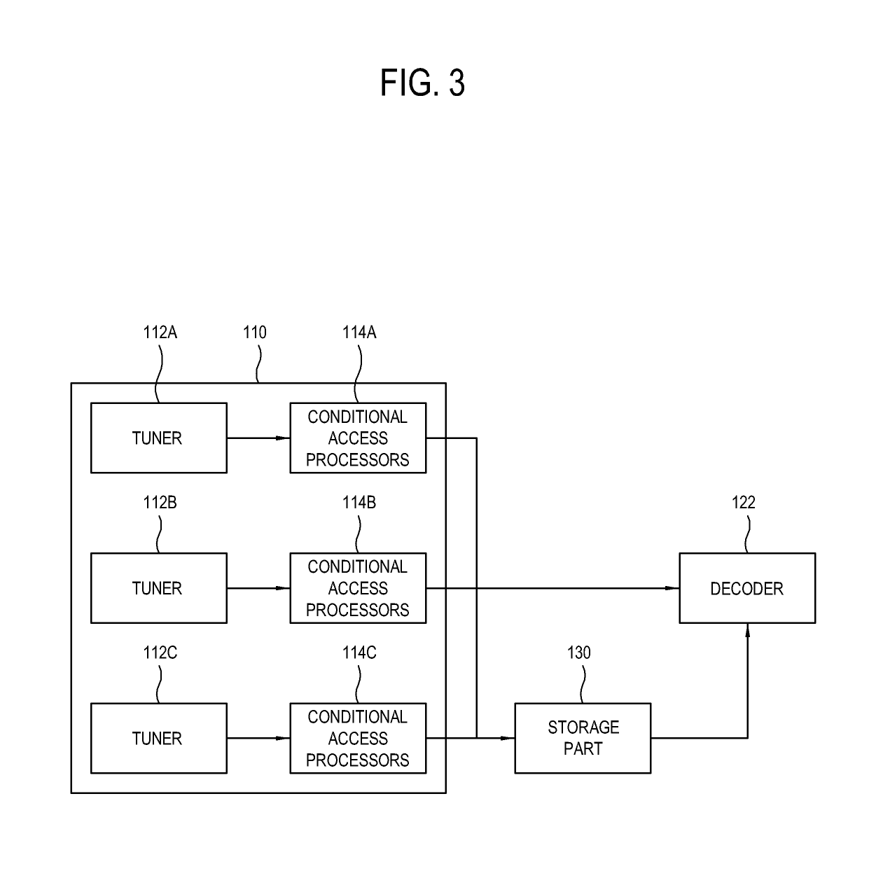

The receiver 110 receives a broadcasting signal from the outside. The received broadcasting signal may be transmitted through various routes such as terrestrial, cable, satellite, Internet Protocol (IP), etc. and the receiver 110 may be configured to have a receiving function in compliance with specifications of the broadcasting signal. The receiver 110 may be configured to include a plurality of tuners to simultaneously receive broadcasting signals from various channels. The respective tuners may be implemented as multi-tuners to receive digital broadcasting signals in various frequency bands. The receiver 110 may be configured to include a plurality of processors 120 corresponding to the plurality of tuners, and the detailed configuration of the receiver 110 including the plurality of processors 120 will be described later with reference to FIG. 3.

The processor 120 is configured to perform preset image processing operations with respect to an image included in the broadcasting signal received by the receiver 110. The image processing operations of the processor 120 may include, e.g., a decoding operation corresponding to various image formats, a de-interlacing operation, a frame refresh rate conversion, a scaling operation, a noise reduction operation for improving a quality of an image, and a detail enhancement operation, but not limited thereto. The processor 120 may be implemented as individual elements which may be configured to independently perform the foregoing operations, or as an integrated element configured to perform the foregoing elements collectively.

The storage 130 may be configured to store therein an image received by the receiver 110. The storage part 130 may be implemented as a known non-volatile memory such as a flash memory, and may store various contents including an channel information image (to be described later).

The user input 150 is configured to receive a user's input signal. The user's input may include inputs for turning on or off the broadcasting receiving apparatus 100, changing the channel or volume, changing the display setting, loading and controlling an electronic program guide (EPG) (to be described later). The user input 150 may be implemented as a button configured to receive wireless signals such as infrared (IR), Bluetooth, or Wireless LAN corresponding to a user's input from a remote control device such as a remote controller, a touch pad, a keyboard and a smartphone, or as a plurality of soft and/or hard buttons provided in an external part of a casing of the broadcasting receiving apparatus 100.

The display 170 is configured to display an image. The display 170 may include a display panel (not shown) such as a liquid crystal display (LCD), plasma display panel (PDP), or organic light emitting diodes (OLED) to display an image, and a panel driver (not shown) to perform timing control to display an image on the display panel. The image displayed may be configured to include an image into which a broadcasting signal such as terrestrial, cable and satellite is processed, and an EPG which is generated by the EPG generator 160 (to be described later). The broadcasting receiving apparatus 100 according to the exemplary embodiment may be implemented as a set-top box, in which case the display 170 may be omitted.

The controller 140 may be implemented as a processor such as a central processing unit (CPU) configured to control overall elements of the broadcasting receiving apparatus 100 according to the exemplary embodiment. The controller 140 may be configured to operate hardware/software of the broadcasting receiving apparatus 100 through an operating system (OS) such as Windows, Linux, Android and Bada, and may be configured to execute application programs installed therein to perform a predetermined operation.

The controller 140 is configured to control at least one of the plurality of tuners, which does not tune to the currently viewed image out of the plurality of tuners of the receiver 110, to alternately tune to a plurality of channels for a preset time. If a user selects a desired channel, a tuner may tune to the selected channel and other tuners may not operate. The controller 140 may be configured to control the other tuners to alternately tune to the plurality of channels for a preset time, e.g., 3 seconds to 1 minute. If channels which may be tuned to by the broadcasting receiving apparatus 100 are No. 1 to 100, four channels may be simultaneously received by the receiver 110, and the remaining 3 tuners, excluding one tuner tuning to the currently viewed channel may sequentially tune to channels no. 1 to 3, and 4 to 6. If there are a plurality of available channels, only a part of the channels may be selected and tuned. In this case, the tuners may tune to several channels or dozens of channels which are expected to be changed by a user on the basis of viewing history, user information, etc. In this case, the channels may be sequentially tuned to in the expected order. The order of tuning to the channels by the plurality of tuners may be based on the organization of a storyboard of a mosaic EPG, which will be described later in detail.

The controller 140 is configured to control the storage 130 to store channel information images corresponding to respective channels based on the image tuned by the at least one tuner. As explained above, the receiver 110 alternately tunes to a plurality of channels through remaining tuners which are not currently used, and the controller 140 controls the storage 130 to store the images of the alternately tuned channels as images according to a preset format.

The channel information images may include a video clip for a preset time or a slide generated from the extracted intra-coded frame (I-frame) of the tuned images. For example, if the remaining tuners are set to alternately tune to respective channels on a 10 seconds basis, images which are received for approximately 8 to 9 seconds, excluding the time taken to tune to another channel, may be stored as video clips in the storage 130. The received image signal includes all encoded audio and video signals, but only the video signal may be stored, or all of audio and video signals may be stored. The starting part of the video clip may be independently decoded like the I-frame and may be stored starting from a displayable frame.

In another exemplary embodiment, the channel information images may be implemented as a plurality of slides including a plurality of frames rather than video. An MPEG transport stream may include an independently encoded I-frame, and a predictive coded frame (P-frame) generated by using motion compensated prediction from the information of the I-frame, a bi-directionally predictive coded frame (B-frame) which is generated by using bi-directional code prediction. The I-frame may be independently decoded, and may be extracted from the transport stream to form a slide.

In the exemplary embodiment, the channel information image is generated from an image of a channel tuned to by the remaining tuner of the plurality of tuners of the receiver 110, but may employ EPG information included in the received broadcasting signal. That is, if a broadcasting signal transmitted by a broadcasting station includes EPG information, such EPG information may be extracted and stored in the storage 130. The EPG information may be used as the channel information image. For example, in the case of a channel including EPG information, the EPG image is stored as is, and the remaining channels may be tuned to by remaining channels to generate channel information images.

The broadcasting receiving apparatus 100 according to the exemplary embodiment may be configured to receive a digital broadcasting signal through the receiver 110. The digital broadcasting takes more to change a channel than analog broadcasting, mainly due to command processing, network delay, descrambling of signals scrambled by conditional access system (CAS), or digital rights management (DRM), and MPEG decoding. In this case, about 2 to 3 seconds may be taken between requesting a change of a channel by a user and outputting an image of a tuned channel, and continuity of viewing may not be guaranteed for a user.

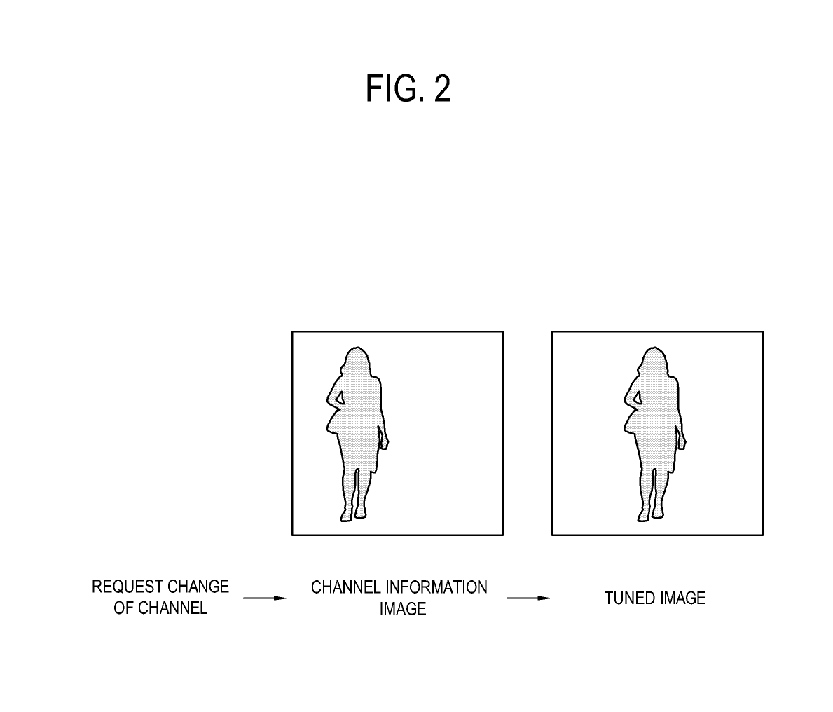

If a request for changing a channel is input by the user input 150, the controller 140 outputs the image corresponding to the requested channel. As explained above, it may take a predetermined time to tune to the requested channel. Thus, as shown in FIG. 2, upon receiving a request for changing a channel, the controller 140 immediately outputs the channel information image corresponding to the requested channel, out of the channel information images stored in the storage 130. Next, if the tuning of to the requested channel is completed, the controller 140 suspends outputting the image and outputs an image of the channel. The channel information image may be stored in the size of the originally received image, and thus may be output immediately after being decoded, without any additional scaling.

Accordingly, a user is provided with the image of the program while waiting to view the program after requesting the change of channel, thereby experiencing a shorter channel changing time.

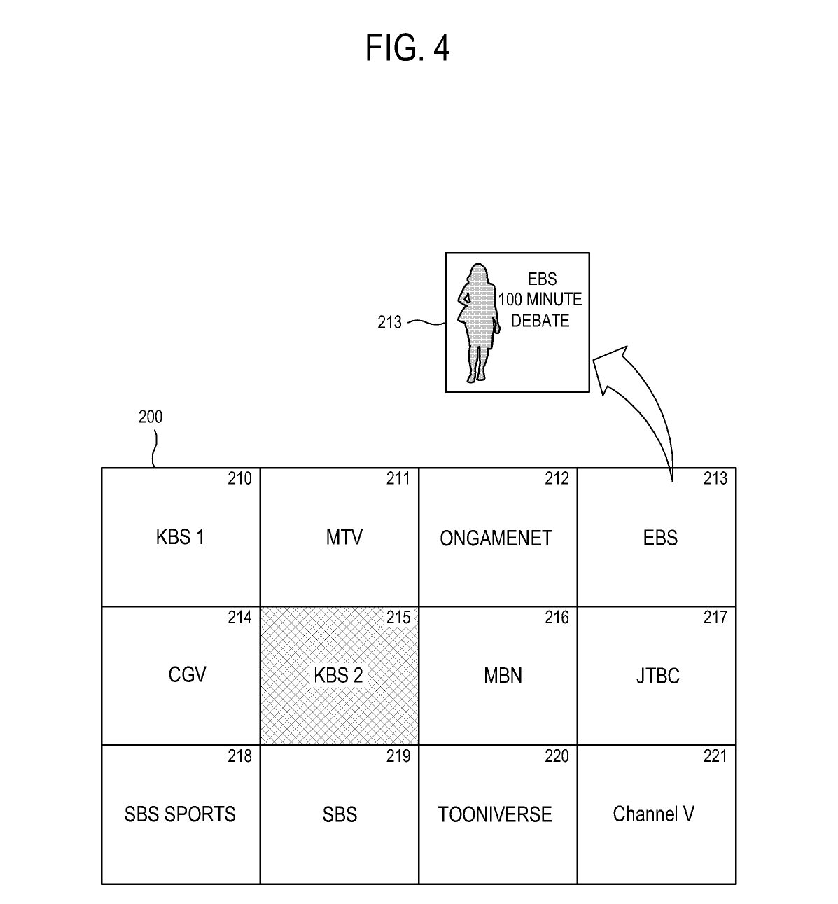

The broadcasting receiving apparatus 100 according to the exemplary embodiment may further include an EPG generator 160 configured to generate EPG information to guide the change of the channel. The EPG is configured to provide broadcasting information of respective channels which may be received through the broadcasting receiving apparatus 100, and may be formed as a separate layer from the image into which a broadcasting signal is processed, and may be overlaid and displayed on the display 170. The EPG may be configured in a mosaic as will be described later, and the form of the EPG and related technical features according to the present exemplary embodiment will be described in detail with reference to FIGS. 4 to 7.

FIG. 3 illustrates a detailed configuration of the receiver 110.

As shown, the receiver 110 includes a plurality of tuners 112A, 112B and 112C, and may further include processors 114A, 114B and 114C connected to an output terminal of the respective tuners 112A, 112B and 112C. FIG. 3 illustrates three tuners 112A, 112B and 112C, and three processors 114A, 114B and 114C, but the number of tuners and processors is not limited thereto. There is no need to provide the processors 114A, 114B and 114C in the output terminal of all of tuners 112A, 112B and 112C.

The tuners 112A, 112B and 112C are configured to tune to channels by the controller 140 and to receive image signals. The tuner 112A of the plurality of tuners 112A, 112B and 112C may be configured to tune to the currently viewed channel, and the remaining tuners 112B and 112C may alternately tune to a plurality of channels for a preset time.

The processors 114A, 114B and 114C descramble images transmitted by the connected tuners 112A, 112B and 112C, based on a right to access. The input broadcasting signal may be scrambled according to CAS or DRM to be transmitted. The broadcasting receiving apparatus 100 configured to receive the broadcasting signal may view an image of the broadcasting signal only when it has the right to view the concerned program. The processors 114A, 114B and 114C check whether the broadcasting receiving apparatus 100 has information on the right to view the concerned program, and if so, descramble the scrambled broadcasting data.

The image descrambled by the processors 114A, 114B and 114C is stored in the storage part 130. If a request for changing a channel is input by the user input 150, the controller 140 may control the decoder 122 to decode and output the descrambled image. As the duration for descrambling the image is reduced, the image may be immediately output upon request for changing a channel, and the image is stored in a smaller size in the storage 130 as it is stored before being decoded.

FIGS. 4 to 7 illustrate examples of the EPG according to the exemplary embodiment.

If a request for displaying an EPG is input through the user input 150, the EPG generator 160 generates and outputs an EPG 200. As shown, the EPG generator 160 may be configured to generate the EPG 200 in the form of a mosaic, and respective mosaics 210 to 221 may include images corresponding to the respective channels. The mosaics of the EPG 200 may be arranged in various formats, and may be formed by a preset storyboard.

As shown in FIG. 4, the EPG may be configured in a square in a two-dimensional manner. Channels which are expected to be changed may be arranged adjacently to the focused area. For example, the aforementioned channels may be arranged in the order of channel number on the basis of the currently viewed channel, arranged on the basis of viewing history, or arranged in the order of channels in similar genres to that of the currently viewed channel.

In an exemplary embodiment, if a user is viewing KBS2 channel 215 as shown in FIG. 4, CGV 214, SBS 219, MBN 211 and MTV 216, which are those channels viewed recently, may be arranged in an upper, lower, left and right mosaic, and the channels which have been viewed previously, may be sequentially arranged in adjacent mosaics. If the broadcasting receiving apparatus 100 displays a 3D image, the EPG 200 may be implemented as a 3D image.

If the EPG 200 is initially displayed, the mosaic area 215 of the currently viewed channel may be focused and displayed. According to a user's subsequent input through a remote control device, the focus may move to another mosaic area, or a channel of the focused mosaic may be selected and tuned.

The respective mosaics 210 to 221 in FIG. 4 may include channel information images. That is, the EPG generator 160 may be configured to generate respective mosaics by including the image corresponding to the respective channels stored in the storage 130, in the respective channel areas. The respective mosaics 210 to 221 may form the EPG by overlaying the images and a text or graphic including channel name, current program title and other channel information.

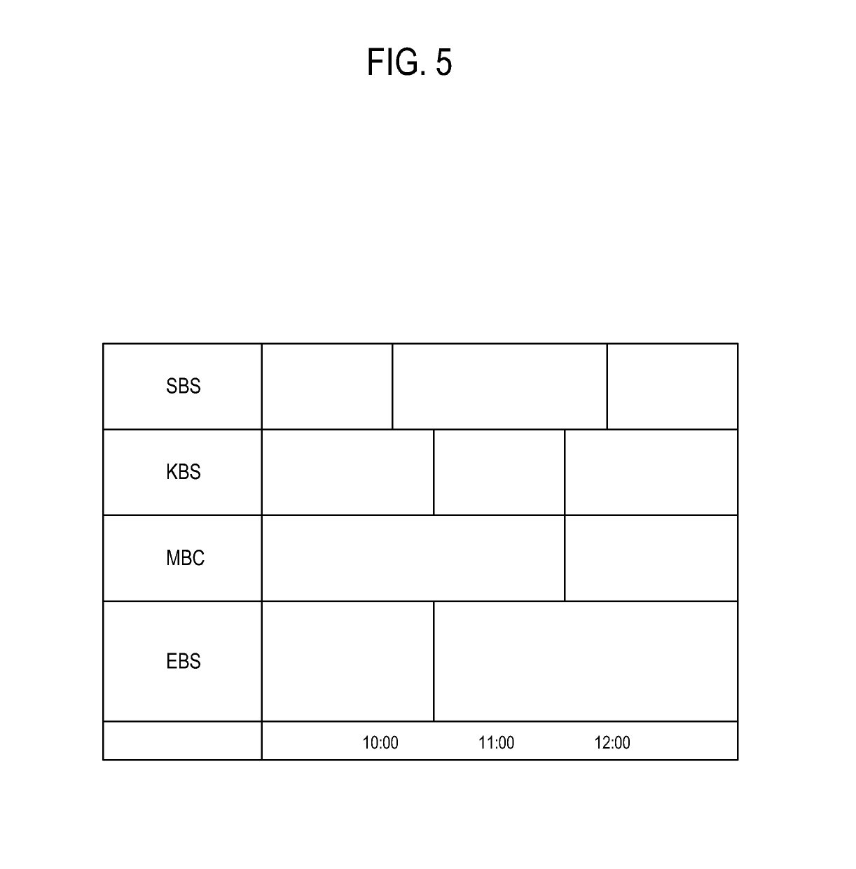

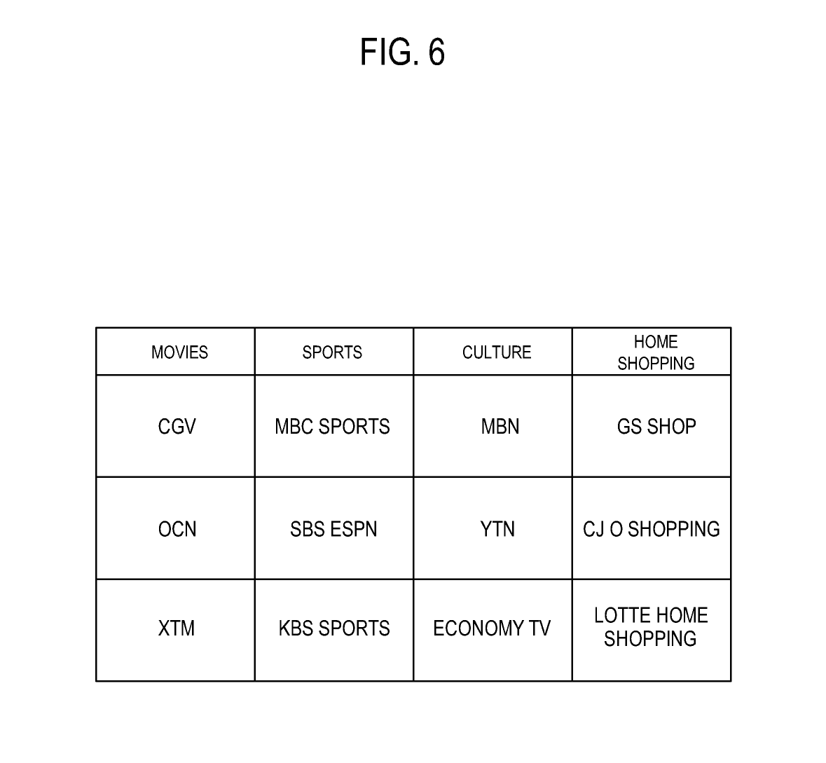

The mosaic-shaped EPG may have a transverse axis as time axis, and a vertical axis as channels to display available programs as respective blocks at those times, as shown in FIG. 5. The EPG may also be classified into genres and displayed per genre as in FIG. 6.

As explained above, the EPG generator 160 may be configured to arrange channels which are very likely to be changed by a user, adjacently to the currently viewed channel. Accordingly, the controller 140 may be configured to sequentially tune to channels in the order of channels corresponding to the mosaics adjacent to the focused mosaic in the EPG and store the channel information images. For example, if the KBS2 channel 215 is currently focused in FIG. 4, the controller 140 may preferentially tune to the CGV 214, SBS 219, MBN 216 and MTV 211 which are adjacently arranged to the KBS2 channel 215 and tune to other channels in the order of mosaics and generate channel information images corresponding to respective channels. As explained above, the EPG generator 160 may be configured to display the mosaics of channels which are expected to be changed by a user, adjacently to the focused channel. If the controller 140 tunes to the channels in the order of adjacent mosaics and generates the images, then the time difference between the image of the tuned broadcasting signal and the channel information image is minimized and continuity of viewing may be guaranteed when a user requests a change of a channel.

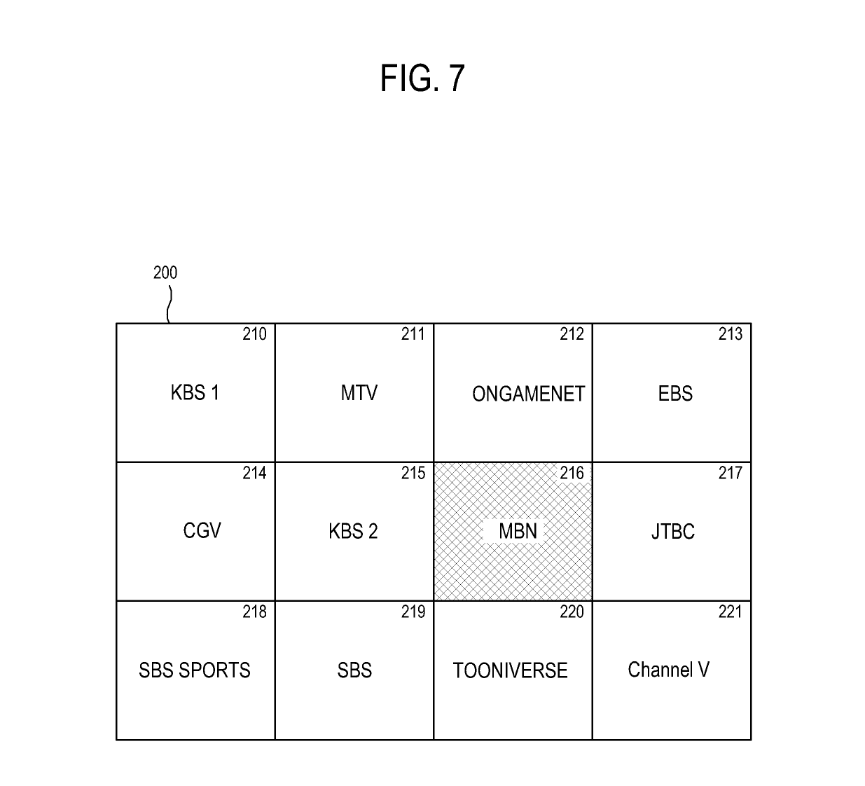

If the focused mosaic is moved without a user's request for changing a channel while the EPG 200 is displayed, the controller 140 controls the receiver 110 to alternately tune to the channels in the order of the adjacent distance from the mosaic to which the focus is moved. As shown in FIG. 7, if the focused mosaic is moved to the MBN channel 216, the controller 140 may control the receiver 110 to preferentially tune to the Ongamenet 212, JTBC 217, Tooniverse 220 and KBS2 215, which are adjacently located to the MBN 216, and generate images, and may tune to other channels in the order of adjacency and generate channel information images.

If a user requests a change to the focused channel while the EPG 200 is displayed, the controller 140 outputs a channel information image of the requested channel, and if the tuning is completed, suspends outputting the channel information image and outputs the tuned image. In this case, the remaining tuners of the plurality of tuners of the receiver 110 may continue to tune to channels in the order of the adjacent mosaics and generate channel information images.

According to the exemplary embodiment, the broadcasting receiving apparatus 100 may be configured to provide the EPG for a user to efficiently search channels and provide a user with the pre-stored channel information images during the channel-changing time, and guarantee continuity of viewing during the channel-changing time.

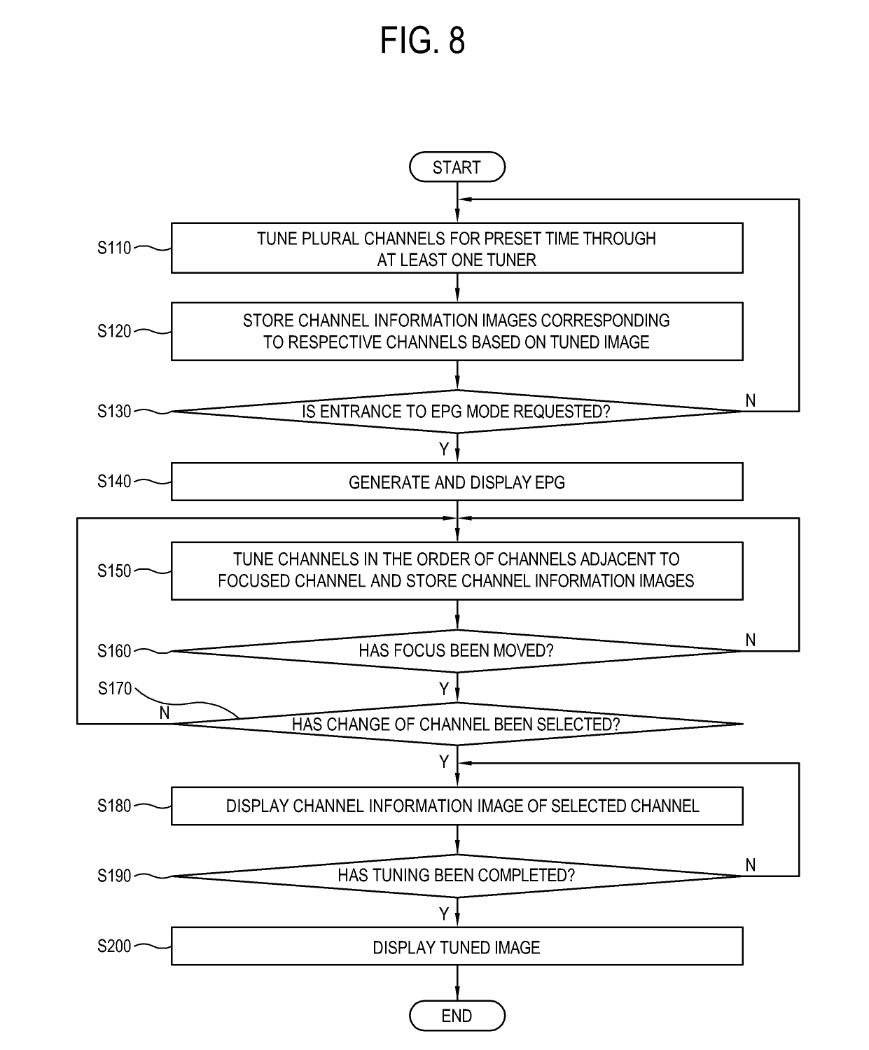

FIG. 8 is a control flowchart of the broadcasting receiving apparatus 100 according to the exemplary embodiment.

The broadcasting receiving apparatus 100 may be configured to receive and transmit, a broadcasting signal, and may be implemented as a set-top box or a DTV.

The broadcasting receiving apparatus 100 configured to include a plurality of tuners, alternately tunes to a plurality of available channels for a preset time by using at least one of tuners which does not tune to the viewed image, out of the plurality of tuners (S110). In this case, if the channels which may be tuned to by the broadcasting receiving apparatus 100 are no. 1 to 100, and the receiver 110 may receive four channels at a time, the broadcasting receiving apparatus 100 may sequentially tune to channels from 1 to 3 and 4 to 6 through the remaining three tuners excluding one tuner tuning to the currently viewed channel. If there are a plurality of available channels, only a part of the channels may be selected and tuned. In this case, only several or dozens of channels which are expected to be changed by a user based on the user's viewing history, user information, etc. may be tuned, and the channels may be sequentially tuned to in the order of the expected channel change.

The broadcasting receiving apparatus 100 may be configured to store channel information images corresponding to the respective channels, based on the tuned image (S120). To do so, the broadcasting receiving apparatus 100 may be configured to include a memory to store therein channel information images. The channel information images may include a video clip for a preset time or a slide generated by extracting the I-frame of the tuned image. In another exemplary embodiment, if a broadcasting signal is transmitted by a broadcasting station includes EPG information, such EPG information may be extracted and stored in the storage 130, and used as the channel information image explained herein.

The broadcasting receiving apparatus 100 may be configured to descramble the image transmitted by the plurality of tuners based on the right to access, and store the plurality of descrambled channel information images.

Upon receiving a user's request for entering the EPG mode (S130), the broadcasting receiving apparatus 100 generates and displays the EPG for providing a user with broadcasting information of respective channels (S140). In this case, the EPG may include mosaics corresponding to respective channels. The channels which are expected to be changed may be arranged adjacently to the focused area in the EPG including the mosaics. For example, the channels may be arranged in the order of the channel number adjacently to the currently viewed channel, arranged on the basis of the viewing history or arranged in the order of channels of similar genre that is similar to the current viewed channel.

In another exemplary embodiment, the EPG may have a transverse axis as time axis, and a vertical axis as channels to display available programs as respective blocks at those times, as shown in FIG. 5. Otherwise, the EPG may be classified into genres and displayed per genre as in FIG. 6.

The broadcasting receiving apparatus 100 may be configured to sequentially tune channels in the order of channels corresponding to the mosaics adjacent to the focused mosaic in the displayed EPG and store the channel information images (S150). If the focused area is moved (S160), the broadcasting receiving apparatus 100 may sequentially tune to the channels adjacent to the moved focused area (S170). This has been explained above.

If a user's request for changing a channel is received (S170), the broadcasting receiving apparatus 100 immediately outputs the channel information image corresponding to the channel which has been requested to be changed, out of the channel information images stored in the storage 130 (S180). If the tuning to the requested channel is completed (S190), the broadcasting receiving apparatus 100 suspends outputting the channel information images and outputs an image of the tuned channel (S200). The channel information image may be stored in the size of the originally received image, and thus may be output immediately after being decoded, without any additional scaling operation.

According to the present exemplary embodiment, the method of the broadcasting receiving apparatus 100 provides the mosaic EPG for a user to efficiently search channels, and provides a user with stored channel information images during the channel changing time to guarantee continuity of viewing even during such channel changing time.

As described above, a broadcasting receiving apparatus and a method may provide a user with an EPG to efficiently search channels and provide a user with proper content during a channel changing .

Although a few exemplary embodiments have been shown and described, it will be appreciated by those with skill and knowledge in the art that changes may be made in these exemplary embodiments without departing from the principles and spirit of the invention, the range of which is defined in the appended claims and their equivalents.

What is claimed is:

1. A broadcasting receiving apparatus comprising:
a receiver which comprises a plurality of tuners;
a storage configured to store an image received by the receiver; and
a controller configured to control at least one of the plurality of tuners that does not tune to a currently viewed image, to alternately tune to a plurality of channels for preset time, and to control the storage to store channel information images corresponding to respective plurality of channels based on images tuned to by the plurality of channels.

2. The broadcasting receiving apparatus according to claim 1, wherein one of the channel information images comprises a video clip for a preset time or a slide generated from an intra-coded frame (I-frame) extracted from the images tuned to by the plurality of channels.

3. The broadcasting receiving apparatus according to claim 1, wherein if a request for changing a channel to a requested channel is received, the controller outputs a channel information image corresponding to the requested channel, and if a tuning to the requested channel is completed, outputs an image of the tuned channel.

4. The broadcasting receiving apparatus according to claim 1, further comprising an electronic program guide (EPG) generator configured to generate an EPG which comprises broadcasting information of the plurality of channels and a plurality of mosaics corresponding to the plurality of channels,
wherein the EPG generator configured to generate the EPG, the EPG further comprising channel information images of channels corresponding to the plurality of mosaics.

5. The broadcasting receiving apparatus according to claim 4, wherein the EPG generator arranges the plurality of mosaics of the EPG based on at least one from among viewing history, user information and genre.

6. The broadcasting receiving apparatus according to claim 5, wherein the EPG generator generates the EPG by overlaying the channel information images with a text or graphic comprising information of channels corresponding to the mosaics.

7. The broadcasting receiving apparatus according to claim 4, wherein the controller is configured to sequentially tune to channels in an order of channels corresponding to the mosaics which are adjacent to a focused mosaic in the EPG.

8. The broadcasting receiving apparatus according to claim 1, wherein the receiver comprises a plurality of processors configured to descramble images tuned to by the plurality of tuners based on a right to access, and the storage configured to store therein the channel information images descrambled by the plurality of c processors.

9. The broadcasting receiving apparatus according to claim 8, wherein if a request for changing a channel is received, the controller decodes and outputs the channel information images stored in the storage.

10. The broadcasting receiving apparatus according to claim 4, further comprising a display configured to display at least one from among the images currently viewed image, the channel information images of channels corresponding to the plurality of mosaics, and the EPG.

11. A method of broadcasting and receiving comprising:
alternately tuning to a plurality of channels for a preset time through at least one of a plurality of tuners which does not tune to a currently viewed image; and
storing channel information images to respective plurality of channels based on the images tuned to by the plurality of channels.

12. The method according to claim 11, wherein one of the channel information images comprises a video clip for a preset time or a slide generated from an I-frame extracted from the images tuned to by the plurality of channels.

13. The method according to claim 11, further comprising:
receiving a request for changing a channel to a requested channel;
outputting channel information images corresponding to the requested channel; and
outputting an image of the tuned channel if the tuning to the requested channel is complete.

14. The method according to claim 11, further comprising:
generating an EPG configured to provide broadcasting information of the plurality of channels and comprising a plurality of mosaics corresponding to the plurality of channels, wherein
the generated EPG comprises the channel information images of channels corresponding to the plurality of mosaics.

15. The method according to claim 14, wherein the EPG comprises arranging the plurality of mosaics of the EPG based on at least one from among viewing history, user information or genre.

16. The method according to claim 15, wherein the EPG comprises generating the EPG by overlaying the channel information images with a text or graphic comprising information of channels corresponding to the mosaics.

17. The method according to claim 14, further comprising:
sequentially tuning to channels in an order corresponding to the mosaics which are adjacent to the focused mosaic in the EPG and storing the channel information images.

18. The method according to claim 11, further comprising:
descrambling an image tuned to by the plurality of tuners based on a right to access, wherein
the storing of the channel information images comprises storing the plurality of descrambled channel information images.

19. The method according to claim 18, further comprising:
decoding and outputting the stored channel information images if a request for changing a channel is received.

20. The method according to claim 14, wherein the broadcasting receiving apparatus comprises a display configured to display at least one from among the currently viewed image, the channel information images of channels corresponding to the plurality of mosaics, and the EPG.

21. A broadcast receiving apparatus comprising:
a signal receiver which receives a broadcast signal;
a decoder which decodes the received broadcast signal;
a plurality of tuners, one of the plurality of tuners tuning to one of a plurality of broadcast channel frequencies contained within the broadcast signal, and the one of the plurality of tuners tuning to a currently viewed channel;
a processor configured to descramble images provided by the plurality of tuners based on a right of access;
a storage which stores channel information images extracted from the plurality of broadcast channel frequencies tuned to by the plurality of tuners; and
wherein the broadcast signal comprises a broadcast television signal.

22. The broadcast receiving apparatus as claimed in claim 21, further comprising a display which displays the an image of the currently tuned channel selected from a plurality of broadcast channel frequencies.

23. A method for generating an electronic program guide (EPG), the method comprising:
receiving at least one of a plurality of broadcast channel frequencies selected from at least from among the user's viewing history, user information, or genre;
generating channel information images created from the selected broadcast channel frequencies and assembling said channel information images into mosaic form;
overlaying the channel information images with a text or graphic identifying the information from the selected broadcast frequencies; and
sequentially tuning to the selected broadcast frequencies corresponding to the channel information images and storing the images in a storage;
wherein the request for display information is transmitted to the at least one display.
